(19) United States
(12) Patent Application Publication
(10) Pub. No.: US 2009/0307921 A1
(43) Pub. Date: Dec. 17, 2009

(54) LAUNDRY DRYER AND METHOD FOR CONTROLLING THE SAME

(76) Inventors: Sang Hun Bae, Gyeongsangnam-do (KR); Chul Jin Choi, Gyeongsangnam-do (KR); Dong Hyun Kim, Gyeongsangnam-do (KR); Young Bok Son, Gyeongsangnam-do (KR); Heung Jae Kim, Gyeongsangnam-do (KR)

Correspondence Address: KED & ASSOCIATES, LLP, P.O. Box 221200, Chantilly, VA, 20153-1200, US

(21) Appl. No.: 12/304,300

(22) PCT Filed: Jun. 11, 2007
(86) PCT No.: PCT/KR2007/002800

§ 371 Date: Dec. 11, 2008

(30) Foreign Application Priority Data
Jun. 12, 2006 (KR) 10-2006-0052677
Jun. 12, 2006 (KR) 10-2006-0052678
Jun. 12, 2006 (KR) 10-2006-0052679
Jun. 12, 2006 (KR) 10-2006-0052680

(51) Int. Cl. F26B 19/00; D06F 58/04

(52) U.S. Cl. 34/60; 34/132

(57) ABSTRACT

A laundry dryer and a method for controlling the same capable of removing or preventing wrinkles or creases of clothes and the like are disclosed. The laundry dryer includes a selectively rotatable drum, a hot air heater which heats air to supply hot air having a high temperature into the drum, a steam generator which generates steam to supply the steam into the drum, and a safety valve which discharges the steam to an outside when steam flow is interrupted.

### TECHNICAL FIELD

The present invention relates to a laundry dryer and a method for controlling the same, and more particularly to a laundry dryer and a method for controlling the same capable of removing or preventing wrinkles or creases of clothes and the like.

### BACKGROUND ART

A laundry dryer is an electric home appliance which dries washed laundry articles such as clothes using high-temperature air. Generally, the laundry dryer includes a drum for receiving articles to be dried, a driving source for driving the drum, a heater for heating air to be introduced into the drum, a blower unit for sucking or discharging air in the drum and the like.

Laundry dryers may be divided into an electric laundry dryer and a gas-type laundry dryer according to the manner of heating air, i.e., a heater. The electric laundry dryer heats air using electric resistance heat. The gas-type laundry dryer heats air using heat generated by gas combustion. In another way, laundry dryers may be divided into a condensation laundry dryer and an exhaust laundry dryer. In the condensation laundry dryer, humid air which has been heat-exchanged with the articles to be dried in the drum is circulated without being discharged to the outside, and the humid air is converted into condensed water in a separate condenser by heat exchange with outside air to be discharged to the outside. In the exhaust laundry dryer, humid air which has been heat-exchanged with the articles to be dried in the drum is directly discharged out of the laundry dryer. In yet another way, laundry dryers may be divided into a top-loading laundry dryer and a front-loading laundry dryer according to the manner of loading the articles to be dried in the laundry dryer. In the top-loading laundry dryer, the articles to be dried are loaded from the upper side of the laundry dryer. In the front-loading laundry dryer, the articles to be dried are loaded from the front side of the laundry dryer.

### DISCLOSURE OF INVENTION

### Technical Problem

The above-mentioned conventional laundry dryers have the following problems.

Generally, washed and water-extracted laundry articles are loaded in the laundry dryer and then dried. However, the washed laundry articles always have creases and the creases are not completely removed during a drying process in the laundry dryer. Thus, there are drawbacks such that additional ironing is necessary to remove the creases from the laundry articles which have been dried in the conventional laundry dryer.

Further, generally, the wrinkles, creases, folds and the like (hereinafter, commonly referred to as reases occur in the stored or used clothes as well as the washed laundry articles. Thus, it is required to develop an apparatus capable of simply removing the creases occurring in the stored or used clothes.

### Technical Solution

Accordingly, the present invention is directed to laundry dryer and a method for controlling the same that substantially obviate one or more problems due to limitations and disadvantages of the related art.

An object of the present invention is to provide laundry dryer and a method for controlling the same capable of removing or preventing wrinkles or creases of clothes and the like.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a laundry dryer includes a selectively rotatable drum, a hot air heater which heats air to supply hot air having a high temperature into the drum, a steam generator which generates steam to supply the steam into the drum, and a safety valve which discharges the steam to an outside when steam flow is interrupted.

Preferably, a steam hose is disposed between the steam generator and the drum and the safety valve is disposed on the steam hose.

Preferably, the safety valve is disposed adjacent to a leading end of the steam hose.

Preferably, the safety valve includes a case having one side communicating with a steam line connected to the steam generator and the other side communicating with the outside and an opening/closing portion disposed in the case to selectively open or close the case and the steam line.

Preferably, the laundry dryer further includes a pump which selectively supplies water into the steam generator.

Preferably, the laundry dryer farther includes a water supply source for storing water which is connected to a front end of the pump.

Preferably, the pump performs forward and backward pumping and the pump is one of a gear type pump, a pulsating type pump and a diaphragm type pump.

Preferably, the pump is water supply source.

Preferably, the laundry dryer farther includes a main nozzle which sprays steam into the drum, and an main nozzle.

Preferably, the main nozzle is a converging-diverging tube.

Preferably, the main nozzle is bent to the outside at 30 degrees, and the nozzle is a converging-diverging tube.

Further, the nozzle is bent to the outside at 15 degrees.

Preferably, the laundry dryer farther includes a connecting portion which connects the main nozzle with the nozzle.

Preferably, the connecting portion is molded as a single body.

Preferably, the laundry dryer further includes a nozzle which sprays steam into the drum, and an nozzle.

Preferably, the nozzle is substantially a converging-diverging tube, and the eddy generating member is a blade. Further, the blade is formed in a curved shape.

Preferably, a central member is disposed in the nozzle, and the blade is connected between an inner wall of the nozzle and the central member. Further, a channel is formed in the central member.

### Advantageous Effects

The laundry dryer according the present invention has the following effects.

First, it is possible to efficiently remove the the articles to be dried and prevent the dried articles from being creased. Further, it is possible to sterilize the articles to be dried and remove smell from the articles to be dried.

Second, it is possible to efficiently remove the articles without additional ironing.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 shows an exploded perspective view of a laundry dryer according to one embodiment of the present invention;

FIG. 2 shows a cross-sectional view of the laundry dryer shown in FIG. 1;

shows a cross-sectional view of a steam generator shown in FIG. 1;

FIG. 4 shows a configuration of a laundry dryer according to another embodiment of the present invention, which mainly shows a steam generator;

FIG. 5 shows an exploded perspective view of an example of a water supply source shown in FIG. 4;

FIG. 6 shows an exploded perspective view of a water softener shown in FIG. 5;

FIGS. 7 to 9 show perspective views of a partially cat portion of FIG. 5;

FIG. 10 is a side view illustrating a connection structure between the water supply source and a pump shown in FIG. 4;

FIGS. 11 and 12 are cross-sectional views illustrating attachment and detachment of the water supply source;

FIG. 13 shows a perspective view of a modified example of a pin shown in FIG. 9;

FIG. 14 is a cross-sectional view illustrating another connection structure between the water supply source and the pump of FIG. 4;

FIG. 15 schematically shows a cross-sectional view illustrating an example of the pump of FIG. 4;

FIG. 16 shows a cross-sectional view illustrating an example of a nozzle of FIG. 4;

FIGS. 17 and 18 show a cross-sectional view and a perspective view illustrating another example of the nozzle of FIG. 4;

FIGS. 19 and 20 show a cross-sectional view and a perspective view illustrating yet another example of the nozzle of FIG. 4;

FIG. 21 shows a front view illustrating an installation example of the nozzle of FIG. 4;

FIGS. 22 and 23 schematically show cross-sectional views illustrating an example of a safety valve of FIG. 4;

FIG. 24 shows a perspective view illustrating an installation example of components of FIG. 4;

FIG. 25 shows a perspective view illustrating another example of the water supply source shown in FIG. 4;

FIG. 26 shows a method of controlling the laundry dryer according to the embodiment of the present invention; and

FIG. 27 shows a flowchart illustrating a pump controlling method of FIG. 26.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

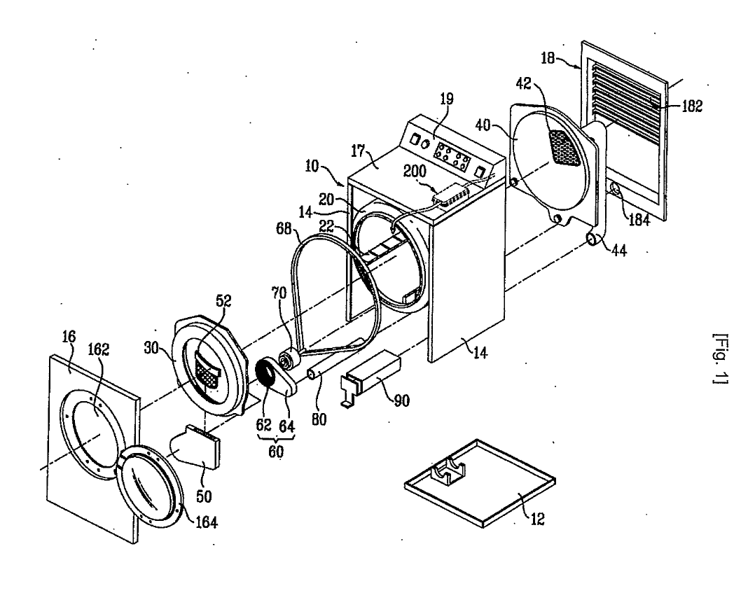

Referring to FIGS. 1 and 2, a laundry dryer and a method of controlling the laundry dryer according to one embodiment of the present invention will be described.

A cabinet 10 forming an appearance of the laundry dryer includes a rotatable drum 20, a motor 70 for driving the drum 20, and a belt 68. The cabinet 10 further includes a heater (hot air heater) 90 for heating air to provide a high-temperature air (hereinafter, referred to as hot air and a hot air supply duct 44 for supplying hot air generated in the hot air heater 90 to the drum 20. Further, the cabinet 10 includes an exhaust duct 80 for exhausting humid air has been heat-exchanged with articles to be dried in the drum 20, and a blower unit 60 for sucking the humid air. Further, a steam generator 200 for generating high-temperature steam is disposed on a specified position of the cabinet 10. An indirect driving type laundry dryer wherein the drum 20 is rotated using the motor 70 and the belt 68 is shown and described in this embodiment, but the present invention is not limited thereto. That is, the present invention may be applied to a direct driving type laundry dryer wherein the motor 70 is directly connected to the rear surface of the dram 20 to directly rotate the drum 20.

Hereinafter, the respective components will be described in detail.

The cabinet 10 forming an outer shape of the laundry dryer includes a base 12 forming a bottom surface, a pair of side covers 14 installed perpendicularly to the base 12, a front cover 16 and a rear cover 18 respectively installed on the front and rear surfaces of the side covers 14, and a top cover 17 disposed on the top of the side covers 14. A control panel 19 having various control switches is generally disposed on the top cover 17 or the front cover 16. A door 164 is disposed on the front cover 16. The rear cover 18 includes suction ports 182 which introduce outside air into the drum 20 and an exhaust hole 184 serving as a final passage which discharges air in the drum 20 to the outside.

An inner space of the drum 20 functions as a drying chamber for performing a drying process. Preferably, the drum 20 includes a lift 22 which lifts up the articles to be dried and drop the articles to be turned inside out in order to increase drying efficiency.

Meanwhile, a front supporter 30 and a rear supporter 40 are disposed between the drum 20 and the cabinet 10 (the front cover 16 and the rear cover 18). The drum 20 is rotatably disposed between the front supporter 30 and the rear supporter 40. Sealing members (not shown) are disposed between the drum 20 and the front supporter 30 and between the drum 20 and the rear supporter 40, respectively. That is, the front supporter 30 and the rear supporter 40 close the front surface and the rear surface of the drum 20 to form a drying chamber and serve to support the front end and the rear end of the drum 20.

An opening is formed on the front supporter 30 such that the drum 20 communicates with the outside of the drum 20. The opening is selectively opened or closed by the door 164. Further, a lint duct 50 is connected to the front supporter 30 to discharge air in the drum 20 to the outside.

A lint filter 52 is installed on the lint duct 50. One side of the blower unit 60 is connected to the lint duct 50 and the other side of the blower unit 60 is connected to the exhaust duct 80. The exhaust duct 80 communicates with the exhaust hole 184 disposed on the rear cover 18.

Accordingly, when the blower unit 60 is operated, air in the drum 20 is discharged to the outside through the lint duct 50, the exhaust duct 80, and the exhaust hole 184. In this case, foreign substances such as nap are filtered in the lint filter 52. The blower unit 60 may include a blower 62 and a blower housing 64. The blower 62 may be connected to the motor 70 for driving the drum 20 and operated by the motor 70. An opening 42 having a number of through-holes is formed on the rear supporter 40. The hot air supply duct 44 is connected to the opening 42.

The hot air supply duct 44 communicates with the drum 20 and serves as a passage for supplying hot air to the drum 20. Thus, a hot air heater 90 is disposed on a specified position of the hot air supply duct 44. Meanwhile, the steam generator 200 which generates steam and supplies the steam into the drum 20 is disposed on a specified position of the cabinet 10.

Referring to FIG. 3, the steam generator 200 is described in detail as follows. The steam generator 200 includes a water tank 210 for accommodating water, a heater 240 disposed in the water tank 210, a water level sensor 260 for measuring a water level in the steam generator 200, and a temperature sensor 270 for measuring a temperature of the steam generator 200. The water level sensor 260 may include a common electrode 262, a low water level electrode 264 and a high water level electrode 266.

The water level sensor 260 detects a low water level or a high water level according to whether the common electrode 262 is electrically connected to the low water level electrode 264 or whether the common electrode 262 is electrically connected to the high water level electrode 266. A water supply hose 220 for supplying water is connected to one side of the steam generator 200. A steam hose 230 for discharging steam is connected to the other side of the steam generator 200.

Preferably, a nozzle 250 having a specified shape is disposed on a leading end of the steam hose 230. Generally, one end of the water supply hose 220 is connected to an external water supply source such as a tap. The leading end of the steam hose 230 or the nozzle 250, i.e., a steam discharge port is disposed on a specified position of the drum 20 to spray steam into the drum 20. Meanwhile, the steam generator 200 described in this embodiment is a tank-heating type steam generator, which heats a specified amount of water accommodated in the water tank 210 having a predetermined size by the heater 240 to generate steam, but the present invention is not limited thereto.

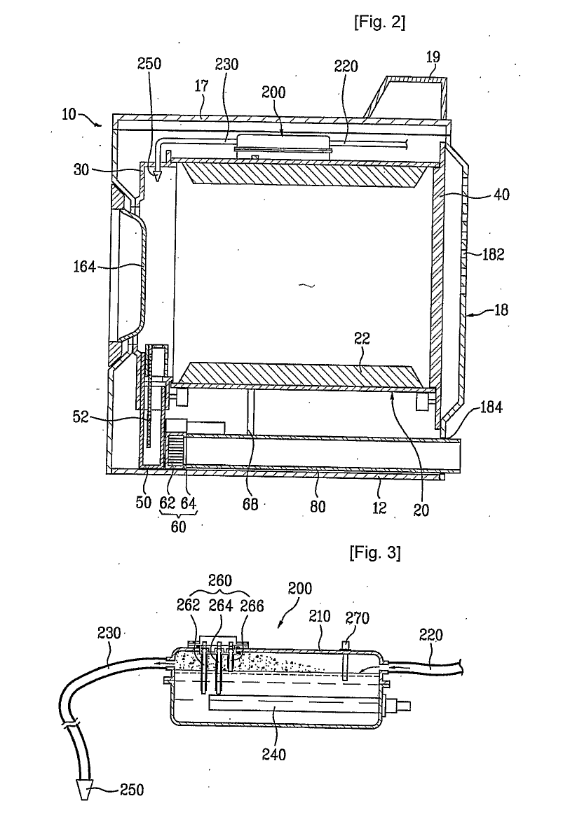

That is, any device capable of generating steam may be applied to the steam generator 200 in the present invention. For example, the steam generator 200 may be a pipe-heating type steam generator, wherein a heater is directly disposed around the water supply hose in which water flows to heat water without holding water in a certain place. Referring to FIG. 4, a laundry dryer according to another embodiment of the present invention will be described. In this embodiment, a water supply source for supplying water into the steam generator 200 may be detachably disposed on the laundry dryer.

As in the above-described embodiment, the water supply source may be a tap. However, since water is not used in the laundry dryer, it is necessary to additionally install various devices in case of using a tap as a water supply source, thereby making it complicated to install the tap on the laundry dryer.

Thus, a detachable water supply source 300 is conveniently used in this embodiment such that water is supplied into the water supply source 300 while being detached and the water supply source 300 containing the supplied water is connected to a water supply line of the steam generator 200, i.e., the water supply hose 220. Further, it is preferable that a pump 400 is disposed between the water supply source 300 and the steam generator 200. The pump 400 may rotate forward and backward.

The pump 400 may supply water in the steam generator 200 and collect remaining water from the steam generator 200. It is possible to supply water into the steam generator 200 using a water level difference between the steam generator 200 and the water supply source 300 without using the pump 400.

However, since various parts of the laundry dryer are typically standardized goods and are compactly arranged, a structural space is absolutely insufficient. Accordingly, if the sizes of various parts of the conventional laundry dryer do not change, it is substantially impossible to supply water using the water level difference. Thus, it is very efficient to use a small-sized pump 400 since the steam generator 200 and the like can be installed without changing the sizes of various parts of the conventional laundry dryer.

Further, remaining water should be collected and removed from the steam generator 200 because the heater may be damaged by the remaining water or corrupt water may be used if the steam generator 200 is not used for a long period of time. Further, water supply and steam discharge are performed at the upper portion of the steam generator 200 in the above embodiment.

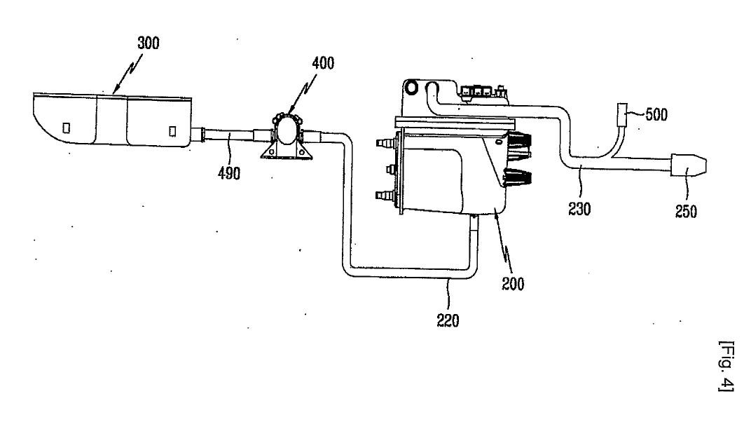

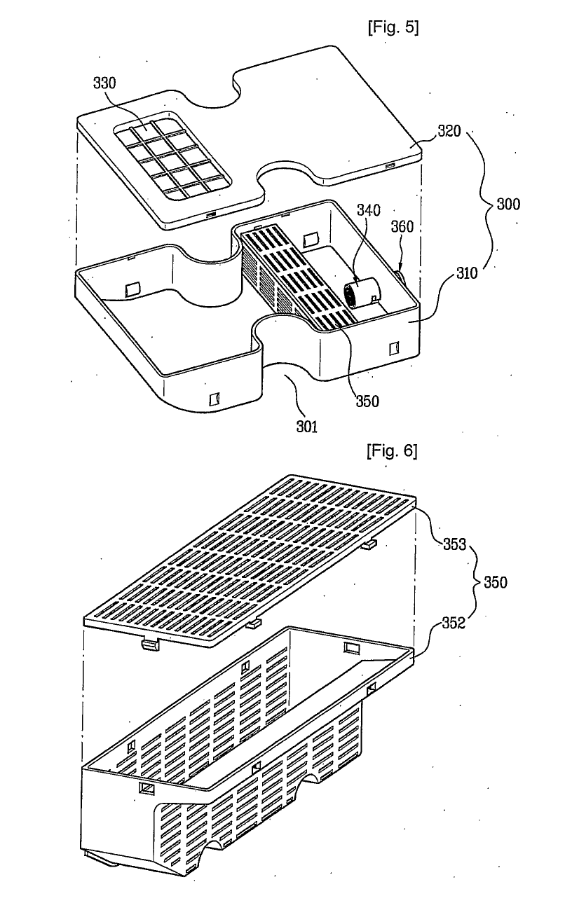

However, preferably, water is supplied into the lower portion of the steam generator 200 and steam is discharged at the upper portion of the steam generator 200 in this embodiment such that remaining water can be efficiently collected from the steam generator 200. Further, it is preferable to dispose a safety valve 500 on a steam line, i.e., the steam hose 230 for discharging steam in the steam generator 200. The respective components are described in detail. First, referring to FIG. 5, the detachable water supply source 300 (hereinafter, simply referred to as a cartridge is described in detail. The cartridge 300 includes a lower housing 310 for substantially accommodating water and an upper housing 320 detachably disposed on the lower housing 310.

When the cartridge 300 includes the lower housing 310 and the upper housing 320, it is easy to clean fur formed in the cartridge 300. Further, it is easy to separate filters 330 and 340 and a water softener 350 and the like from the cartridge 300 for cleaning or recycling.

preferable to dispose a first filter 330 in the upper housing 320. That is, the first filter 330 is disposed at a water inlet portion of the upper housing 320 to primarily filter water when water is supplied into the cartridge 300. An opening/closing member 360 is disposed on the lower housing 310 to selectively supply water in the cartridge 300 to the outside.

Preferably, water is not discharged from the cartridge 300 to the outside in separation of the cartridge 300, whereas water is discharged from the cartridge 300 to the outside in installation of the cartridge 300. Preferably, a second filter 340 for filtering water is connected to the opening/closing member 360. More preferably, the second filter 340 is detachable.

It is possible to doubly filter impurities such as fine dust particles from the water. Preferably, the first filter 330 has an about 50 mesh net and the second filter 340 has an about 60 mesh net. In this case, the number of meshes per a specified area is fifty in the 50 mesh net. Accordingly, mesh pores of the first filter 330 has a larger size than that of mesh pores of the second filter 340.

Thus, large foreign substances are primarily filtered in the first filter 330 and small foreign substances are secondarily filtered in the second filter 340. Further, preferably, the water softener 350 is disposed in the cartridge 300 to soften water. More preferably, the water softener 350 is detachable.

As shown in FIG. 6, the water softener 350 includes a lower housing 352 having a number of through-holes, an upper housing 353 detachably disposed on the lower housing 352 to have a number of through-holes, and ion exchange resin (not shown) filled in a space defined by the upper housing 353 and the lower housing 352. The water softener 350 is used for the following purpose. When water supplied into the steam generator 200 has a high hardness, calcium hydrogen carbonate (Ca(HCO₃)₂) dissolved in the water is heated to precipitate lime (calcium carbonate (CaCO₃) and the like). The lime may corrode the heater.

Particularly, since water in Europe and American States is soft water having a high hardness, such a phenomenon may frequently occur. Thus, it is preferable to remove calcium, magnesium ions and the like in advance using the ion exchange resin so as to prevent precipitation of lime. Further, since the performance of the ion exchange resin is deteriorated as water is softened, the ion exchange resin may be reproduced by salt (sodium chloride, NaCl) to be reused.

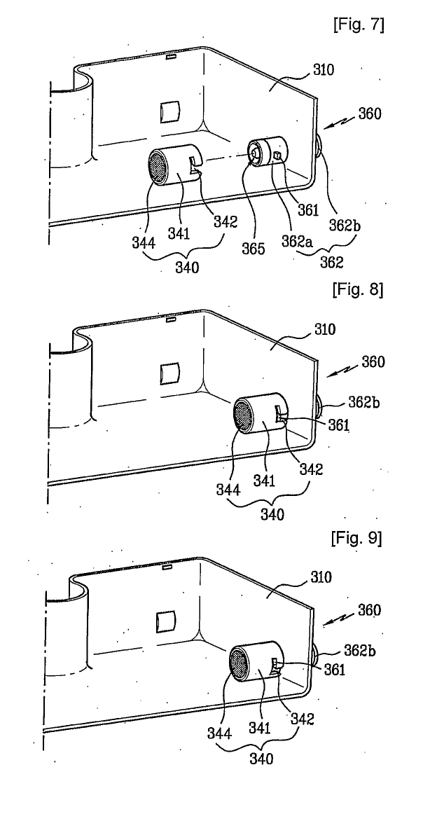

For reference, a softening process using the ion exchange resin is represented by 2(R—SONa)+Ca₂(R—SO)Ca+2Na, and a reproduction process is represented by (R—SO)Ca+2NaCl 2(R—SONa)+CaCl. Referring to FIGS. 7 to 9, attachment and detachment of the second filter 340 and the opening/closing member 360 will be described in detail. The opening/closing member 360 which communicates with the cartridge 300 is disposed in the lower housing 310 of the cartridge 300.

The opening/closing member 360 includes a channel 362 communicating with the cartridge 300 and a pin 365 for selectively opening/closing the channel 362. The channel 362 includes an inner channel 362a and an outer channel 362b. An engaging protrusion 361 is formed on the outer surface of the inner channel 362a. The second filter 340 includes a case 341 having a shape corresponding to the inner channel 362a and a filtering section 344 disposed at one side of the case 341.

A groove 342 is formed at one side of the case 341 to correspond to the engaging protrusion 361 of the inner channel 362a. The groove 342 has an approximately L-shape, i.e., a horizontal portion and a vertical portion. Thus, as shown in FIG. 8, the groove 342 of the second filter 340, specifically, the horizontal portion is fitted with the engaging protrusion 361 of the inner channel 362a. Then, as shown in FIG. 9, the second filter 340 is coupled with the opening/closing member 360 by turning the second filter 340.

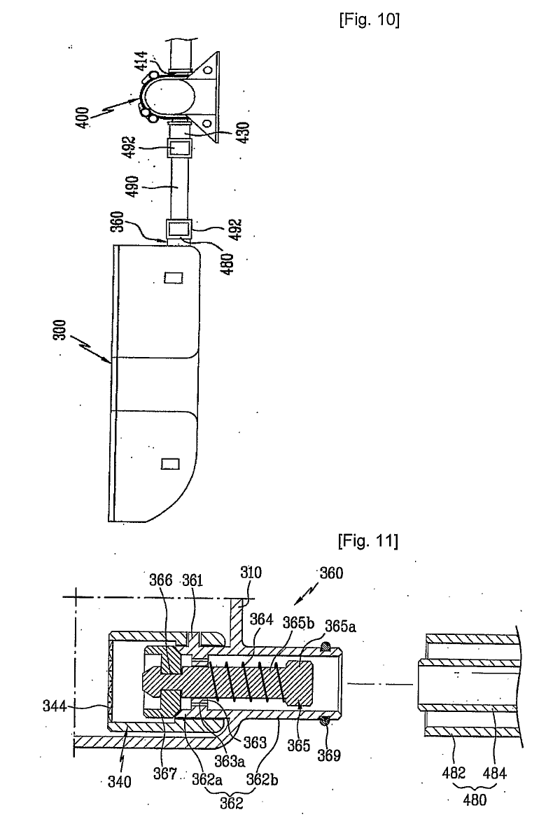

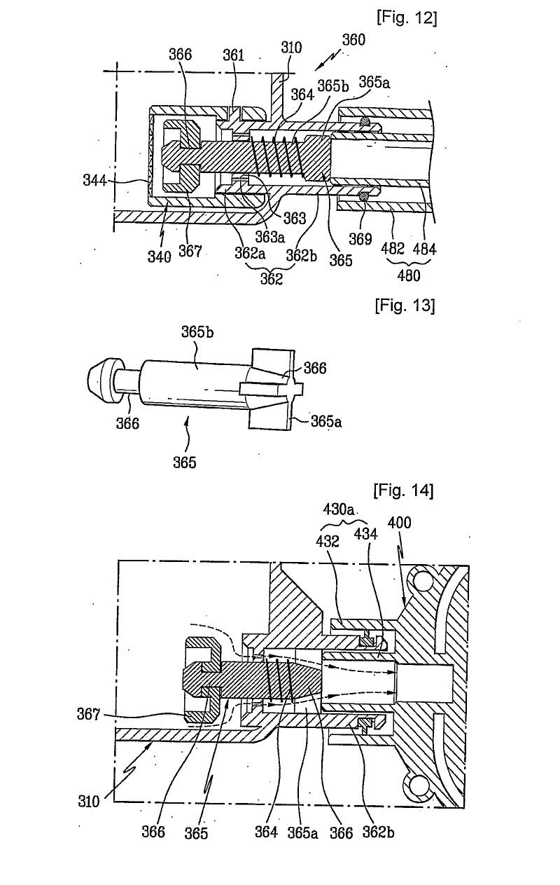

Since the detachment of the second filter 340 is performed in the opposite way, the detailed description thereof is omitted. cartridge 300 and the pump 400 will be described in detail. A shown in FIG. 10, the cartridge 300 and the pump 400 are connected with each other thrash an intermediate hose 490. However, one side of the intermediate hose 490 is directly connected to an introduction port 430 of the pump 400, whereas the other of the intermediate hose 490 is connected to the cartridge 300 thrash a connection port 480.

Preferably, clamps 492 are disposed between the introduction port 430 of the pump 400 and the intermediate hose 490 and between the connection port 480 and intermediate hose 490 to prevent leakage. cartridge 300 and the connection port 480 will be described in detail. opening/closing member 360 is disposed on the cartridge 300 to communicate with the cartridge 300. The opening/closing member 360 includes the channel 362 and the pin 365 for selectively opening/closing the channel 362. The channel 362 includes the inner channel 362a and the cuter channel 362b. An O-ring 369 is disposed on the outer surface of the outer channel 362b for airtightness.

On the other hand, a recess 366 is disposed at one side of a body 365b of the pin 365. A flowing portion 365a (see FIG. 13) is disposed at the other side of a body 365b of the pin 365. An opening/closing portion 367 is disposed on the recess 366. The flowing portion 365a is formed in an approximately cross shape, and water flows between crossed wings. Preferably, the opening/closing portion 367 is made of a rubber material.

support portion 363 having a number of through-holes 363a is disposed in the channel 362 to support the body 365b of the pin 365. A spring 364 is disposed between the support portion 363 and the flowing portion 365a of the pin 365. Further, the connection port 480 includes an outer portion 482 having an inner diameter greater than an outer diameter of the outer channel 362b of the opening/closing member 360 and an inner portion 484 having an outer diameter smaller than an inner diameter of the outer channel 362b.

the cartridge 300 is detached from the connection port 480, the opening/closing portion 367 disposed at one side of the pin 365 closes a leading end of the inner channel 362a by the spring 364. Thus, water in the cartridge 300 is not discharged to the outside through the channel. However, the cartridge 300 is inserted into the connection port 480, the pin 365 proceeds toward the inner channel 362a against an elastic force of the spring 364 by an inner portion 484 of the connection port 480.

Accordingly, the opening/closing portion 367 disposed at one side of the pin 365 is separated from the leading end of the inner channel 362a, whereby water flows through a gap therebetween. Thus, the water in the cartridge 300 is discharged to the outside, i.e., toward the pump 400 through the channel.

Further, a double sealing structure using the spring 364 and the O-ring 369 is applied to the prevent invention to efficiently prevent water leakage. Further, as flowing portion 365a is tapered. By such a configuration, it is possible to more efficiently flow water since the water flow area increases compared to a totally cylindrical shape. Meanwhile, as shown in cartridge 300 may be directly connected to the pump 400 without using the intermediate hose 490.

In this case, an introduction port 430a of the pump 400 should have a modified shape to include an outer portion 432 and an inner portion 434. That is, the introduction port 430a of the pump 400 is configured to have a shape similar to the connection port 480 shown in FIG. 9. By such a configuration, compared to the connection structure shown in FIGS. 9 and 10, the intermediate hose 490, the clamps 492 for sealing and the like can be omitted. Thus, it is possible to reduce the material cost and the number of operation times.

Meanwhile, although the first filter 330, the second filter 340 and the water softener 350 are disposed in the detachable cartridge 300 in the above embodiment, the present invention is not limited thereto. For example, the prevent invention can be applied to a case of using an external tap as the water supply source 300. In this case, it is possible to install at least one of the first filter 330, the second filter 340 and the water softener 350 on the water supply line connected to the steam generator 200.

Also, it is preferable that the first filter 330, the second filter 340 and the water softener 350 are detachably installed. Further, preferably, the first filter 330, the second filter 340 and the water softener 350 are disposed in a single container, which is detachably installed on the water supply line.

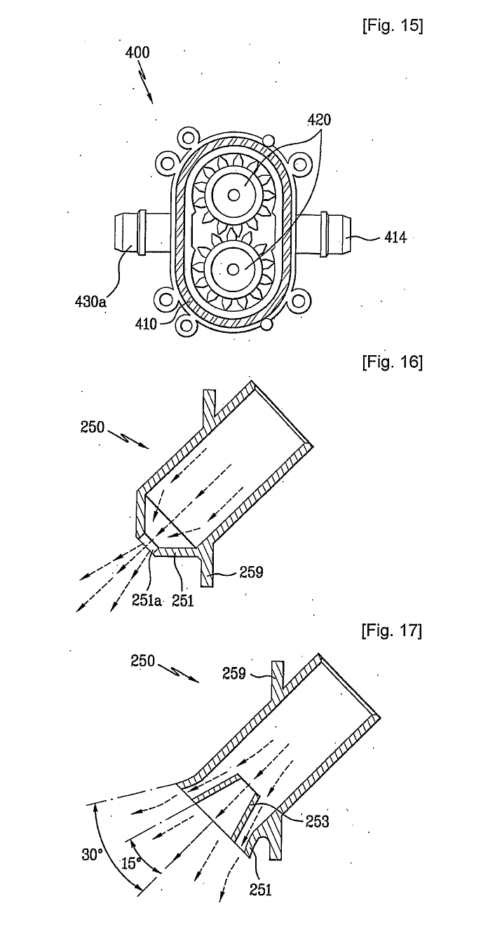

steam generator 200. Preferably, the pump 400 may rotate forward and backward to steam generator 200 or collect water from the steam generator 200. forward and backward by instantaneously varying polarity of a circuit. FIG. 15 shows a nozzle 250 will be nozzle 250 may be configured to have a general shape.

That is, the nozzle 250 may be formed in a converging-diverging tube such that steam is sprayed to the drum through a spraying hole 251a formed at a leading end of the nozzle 250. Further, a support portion 259 for mounting the nozzle 250 may be formed on the nozzle 250.

As shown in FIG. 16, when steam is simply sprayed through the spraying hole 251a formed at a leading end of the nozzle 250, the steam is sprayed to only a small portion of the drum by kinetic energy of the steam, thereby decreasing the performance of removing wrinkles.

Thus, it is preferable to properly change a shape of the nozzle 250. nozzle 250 according to another embodiment is nozzle 250 connected to the steam generator 200 to provide steam to the drum. In this case, preferably, the nozzle 250 has a constant diameter or is formed in a converging-diverging tube.

In case of forming the nozzle 250 in a converging-diverging tube, the leading end 251 may have a slightly greater diameter. The formed in a converging-diverging tube, preferably, a cone shape. An inclination angle at which the is bent to the outside may be smaller than an inclination angle at which the nozzle 250 is bent to the outside.

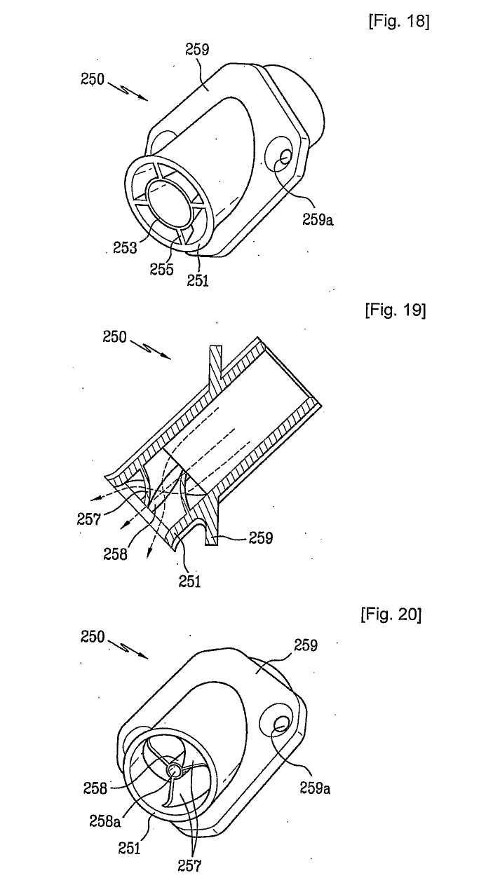

For example, the nozzle 250 is bent to the outside at 30 degrees and the is bent to the outside at 15 degrees. By such a configuration, it is possible to increase a diffusion angle of the steam, thereby spraying the steam all over the clothes. As a result, the performance of removing wrinkles can be improved. Meanwhile, a connecting portion 255 may be disposed between the nozzle 250 and the the nozzle 250 with the nozzle 250, the connecting portion 255 can be molded as a single body, thereby improving moldability, mass productivity and the like. In FIG. 18, reference numeral 259a denotes a coupling hole formed on the support portion 259.

nozzle 250 according to yet another embodiment is nozzle 250. Also in this case, the nozzle 250 may have a constant diameter or be formed in a converging-diverging tube. In case of forming the nozzle 250 in a converging-diverging tube, the leading end 251 may have a slightly greater diameter. The nozzle 250 to the center of nozzle 250. nozzle 250 and the, it is possible to improve moldability, mass productivity and the like. By such a configuration of forming eddies in steam flow, it is possible to increase kinetic energy and a diffusion angle of the steam, thereby spraying the steam all over the clothes.

As a result, the performance of removing wrinkles can be improved. Meanwhile, as shown in FIG. 21, the nozzle 250 may be disposed adjacent to the opening 42 for supplying hot air to the drum such that steam is sprayed from the rear surface of the drum to the front surface of the drum. In the drum, generally, air is introduced into the opening 42 formed in the rear supporter 40 and then discharged to the outside through a lint duct (not shown, see FIG. 1) formed below the door 104. Accordingly, air flow path is roughly from the opening 42 to the lint duct.

Thus, when the nozzle 250 is disposed adjacent to the opening 42, sprayed steam smoothly flows along the air flow path, thereby applying the steam all over the clothes. safety valve 500 is steam generator is normally operated, steam is sprayed into the drum through the steam hose 230 and the spraying hole 251a of the spraying hole 251a may be clogged with the steam generator 200, thereby causing damage on the steam generator and the like.

Particularly, in the tank-heating type steam generator, since the water tank is rarely designed as a highly pressure-resistant tank, the damage may frequently occur. Thus, it is preferable to dispose a proper safety device. When the steam line for flowing steam generated from the steam generator is clogged, the safety valve 500 serves to discharge the steam to the outside.

Accordingly, preferably, the safety valve 500 is disposed on the steam line, for example, the steam hose 230. More preferably, the safety valve 500 is disposed at the leading end of the steam hose 230, for example, a portion adjacent to the nozzle 250. The safety valve 500 includes a case 510 having one side communicating with the steam hose 230 and the other side communicating with the outside, and an opening/closing portion 530 disposed in the case 510 to selectively open or close the case 510 and the steam hose 230. The opening/closing portion 530 is disposed at a steam line communication portion 513 of the case 510.

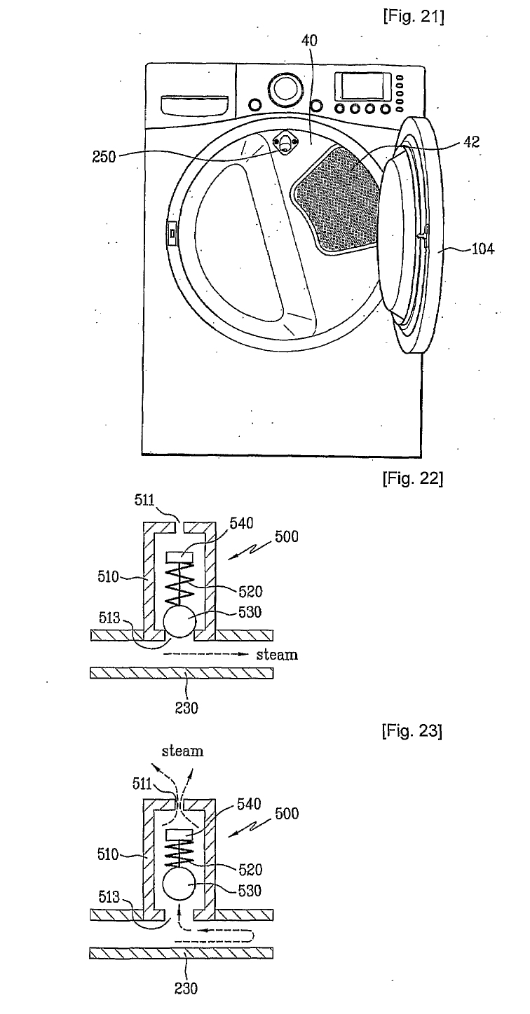

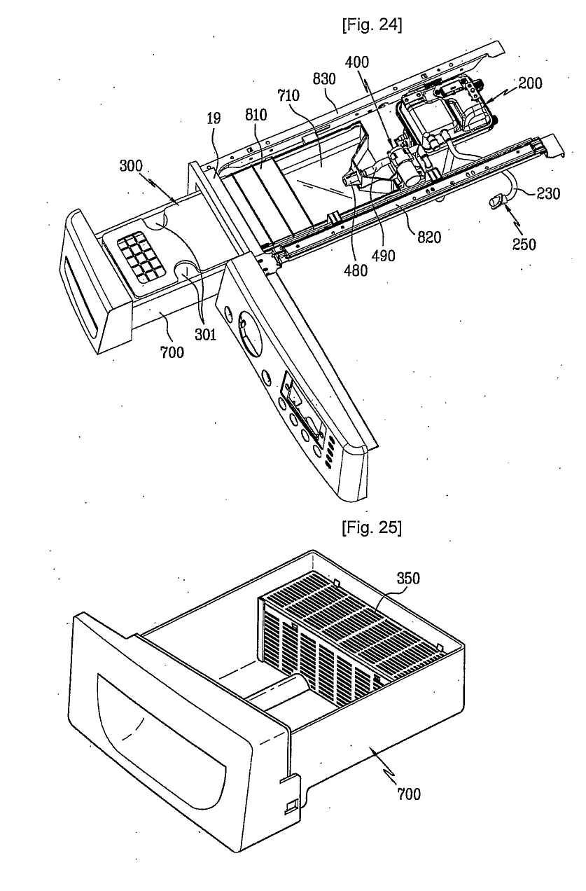

The opening/closing portion 530 is supported by the spring 520. One side of the spring 520 is supported by the opening/closing portion 530 and the other side of the spring 520 is supported by a fixed part 540 which is fixed to the case 510 in a certain way. As shown in FIG. 23, if the steam hose 230 is not clogged to have a pressure smaller than a predetermined pressure, steam cannot overcome the elastic force of the spring 520. Accordingly, the steam line communication portion 513 is closed by the opening/closing portion 530 such that the steam is not discharged to the outside. However, as shown in FIG. 22, if the steam hose 230 is clogged to have a pressure greater than a predetermined pressure, for example, 1 kgf/cm², steam overcomes the elastic force of the spring 520.

Accordingly, the opening/closing portion 530 moves to open the steam line communication portion 513 such that the steam is discharged to the outside through the steam line communication portion 513 and an external communication portion 511. cartridge 300 may be mounted ton the cartridge 300 connection port 480, preferably, the cartridge 300 is mounted on the cartridge 300 to the connection port 480 or separating the cartridge 300 from the connection port 480 in an indirect way. connection port 480 may be disposed on the other side.

As described above, it is preferable to install the cartridge 300 is mounted on the cartridge 300 correspond to both side surfaces of the cartridge 300 with the cartridge 300 for attachment and detachment of the cartridge 300. Accordingly, the cartridge 300 may be attached to or detached from the cartridge 300 is described as follows. When the user extracts the cartridge 300 is extracted at the same time.

Then, the cartridge 300 is detached from the cartridge 300 is supplied with water through a water supply port, for example, the first filter 300 such that the cartridge 300 is filled with water. The cartridge 300 filled with water is mounted on the cartridge 300 is with the connection port 480, and the cartridge 300 is opened to flow the water in the cartridge 300 toward the pump 400.

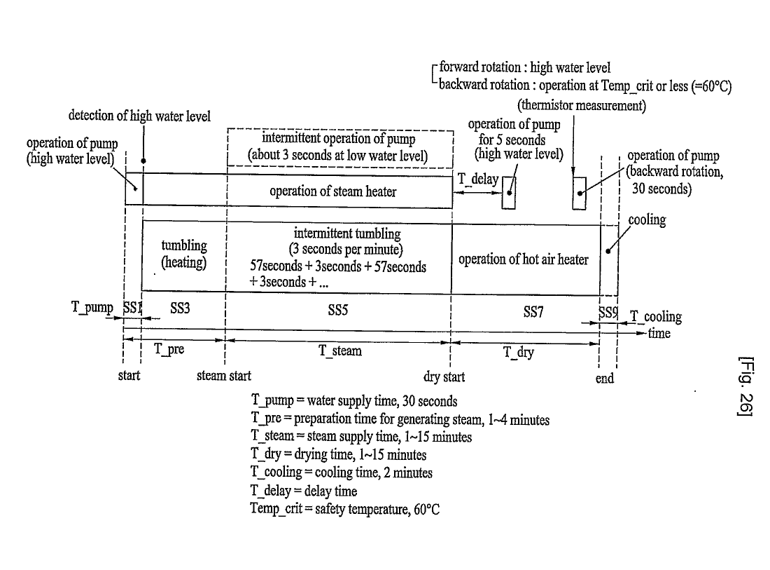

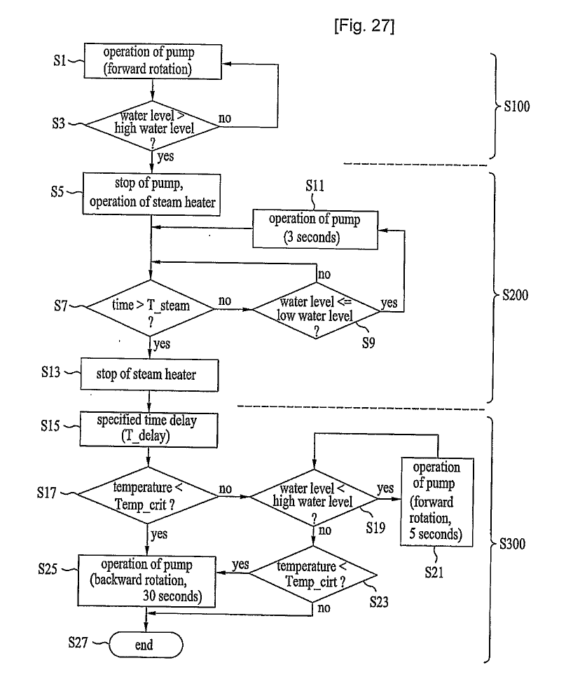

cartridge 300 may be detached from the cartridge 300 includes the upper housing 320 and the lower housing 310 in the present invention, it is easy to clean the detached cartridge 300. Meanwhile, as shown in FIG. 25, the by using cartridge 300 as the water softener 350 is disposed in the first filter 330 and the second filter 340 in the remove the creases in the following step, that is, the the performance of removing creases.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

The The The water-extracted laundry dryer and a method for controlling the laundry dryer according to the present invention, it is possible to efficiently remove the the articles to be dried and prevent the dried articles from being creased. Further, it is possible to sterilize the articles to be dried and remove smell from the articles to be dried. Furthermore, it is possible to efficiently remove the articles without additional ironing.

1. A laundry dryer comprising:
a selectively rotatable drum;
a hot air heater which heats air to supply hot air into the drum;
a steam generator which generates steam to supply the steam into the drum; and
a safety valve which discharges the steam when the steam is at a predetermined pressure.

2. The laundry dryer according to claim 1, wherein a steam hose is disposed between the steam generator and the drum and the safety valve is disposed on the steam hose.

3. The laundry dryer according to claim 2, wherein the safety valve is disposed adjacent to a leading end of the steam hose.

4. The laundry dryer according to claim 1, wherein the safety valve includes a case having one side communicating with a steam line connected to the steam generator and the other side communicating with the outside and an opening/closing portion disposed in the case to selectively open or close the case and the steam line.

5. The laundry dryer according to claim 1, further comprising a pump which selectively supplies water into the steam generator.

6. The laundry dryer according to claim 5, further comprising a water supply source for storing water which is connected to a front end of the pump.

7. The laundry dryer according to claim 6, wherein the pump performs forward and backward pumping.

8. The laundry dryer according to claim 7, wherein the pump is.

9. The laundry dryer according to claim 6, wherein the pump is water supply source.

10. A laundry dryer comprising:
a selectively rotatable drum;
a heater to heat at to be supplied into the drum;
a steam generator to generate steam to be supplied into the drum;
a main nozzle which sprays steam into the drum; and
an auxiliary nozzle disposed in the main nozzle.

11. The laundry dryer according to claim 10, wherein the main nozzle is a converging-diverging tube.

12. The laundry dryer according to claim 11, wherein the main nozzle is bent to the outside at 30 degrees.

13. The laundry dryer according to claim 10, wherein the nozzle is a converging-diverging tube.

14. The laundry dryer according to claim 13, wherein the nozzle is bent to the outside at 15 degrees.

15. The laundry dryer according to claim 10, further comprising a connecting portion which connects the main nozzle with the nozzle.

16. The laundry dryer according to claim 15, wherein nozzle, the connecting portion is molded as a single body.

17. A laundry dryer comprising:
a selectively rotatable drum;
a heater to heat air to be supplied into the drum;
a steam generator to generate steam to be supplied into the drum;
a nozzle which sprays steam into the drum; and
an eddy generating member disposed in the nozzle.

18. The laundry dryer according to claim 17, wherein the nozzle is substantially a converging-diverging tube.

19. The laundry dryer according to claim 17, wherein the is a blade.

20. The laundry dryer according to claim 19, wherein the blade is formed.

21. The laundry dryer according to claim 17, wherein a central member is disposed in the nozzle.

22. The laundry dryer according to claim 21, wherein the blade is connected between an inner wall of the nozzle and the central member.

23. The laundry dryer according to claim 21, wherein a channel is formed in the central member.
